(19) United States
(12) Patent Application Publication
(10) Pub. No.: US 2024/0391156 A1
(43) Pub. Date: Nov. 28, 2024

(54) Article Laminated With Thermoformed Film

(71) Applicant: Celanese International Corporation, Irving, TX (US)

(72) Inventor: TOM GUEST, Belper (GB)

(21) Appl. No.: 18/652,965

(22) Filed: May 2, 2024

Related U.S. Application Data
(60) Provisional application No. 63/469,209, filed on May 26, 2023.

(51) Int. Cl. B29C 51/16; B29C 51/10; B29C 51/26; B29C 51/42; B29K 1/00; B32B 1/00; B32B 3/26; B32B 23/06; B32B 23/20

(52) U.S. Cl. CPC B29C 51/16; B29C 51/10; B29C 51/264; B29C 51/42; B32B 1/00; B32B 3/266; B32B 23/06; B32B 23/20; B29K 2001/12; B29K 2995/006; B29K 2995/0065; B29K 2995/0069; B32B 2250/02; B32B 2255/12; B32B 2255/26; B32B 2307/7163; B32B 2307/724; B32B 2307/7376; B32B 2439/02

(57) ABSTRACT

The present disclosure is directed to laminated articles, such as articles for food and beverages, that are biodegradable and/or paper recyclable. The articles include a substrate comprising a film layer. The film layer is formed from a film made from biodegradable and/or paper recyclable polymer materials. The film layer is resistant and/or impermeable to liquids The article is capable of being frozen and/or heated using, for instance, a microwave oven without delaminating.

### RELATED APPLICATIONS

The present application is based upon and claims priority to U.S. Provisional Application Ser. No. 63/469,209, having a filing date of May 26, 2023, which is incorporated herein by reference.

### BACKGROUND

Each year, the global production of plastics continues to increase. Notably, more than one-half of the amount of plastics produced each year are used to produce plastic bottles, containers, container lids, and other single-use items. The discarded, single-use plastic articles, including all different kinds of packaging, are typically not recycled and generally end up in landfills. Additionally, many of these items end up in streams, lakes, and even oceans. In fact, plastic waste is known to agglomerate and concentrate in oceans in certain areas of the world due to currents and the buoyancy of the products.

In view of the above, significant development work is ongoing in order to produce single-use containers made from biodegradable materials and/or paper recyclable materials. Various problems have been encountered, however, in being able to produce biodegradable and/or paper recyclable containers that are liquid impermeable and/or safe for use in food handling applications.

In the past, food containers have been made from organic pulp materials. In order to make the containers liquid impermeable and grease resistant, however, the organic pulp material has been combined with a polyfluoroalkyl polymer or laminated to a polyethylene film, particularly a crosslinked low density polyethylene film. The use of fluoropolymers or the above described polyethylene films, however, have prevented the containers from being recycled and from being compostable. Consequently, many of these containers are either incinerated or end up in landfills. In addition, recent government regulations have not permitted the use of certain fluoropolymers in food handling applications.

Replacing the polyfluoroalkyl polymer or the fossil-based polyethylene polymer with a bio-based polymer, however, is problematic. Many bio-based polymers do not have sufficient mechanical properties for the above application. In addition, bio-based polymers are typically sensitive to higher temperatures and and can bubble, warp or become damaged during processing or use.

Consequently, a need currently exists for a biodegradable and/or paper recyclable article that is suitable for food handling applications and is liquid resistant and/or impermeable. A need also exists for a method of producing the articles.

### SUMMARY

In general, the present disclosure is directed to producing laminated articles, such as articles for food and beverages, that are biodegradable and/or paper recyclable. In one aspect, for instance, the articles are compostable. The articles include a shaped fibrous substrate that is air permeable and formed from plant fibers. In accordance with the present disclosure, a film made from a biodegradable polymer is laminated to the substrate to produce a liquid impermeable barrier that is capable of being frozen and/or heated using, for instance, a microwave oven. The biodegradable film is laminated to the substrate with a bond strength or peel strength that prevents delamination during freezing, thawing, and/or heating.

For example, in one embodiment, the present disclosure is directed to a composite article that includes a fibrous substrate comprising a network of biodegradable fibers. The fibrous substrate defines a surface. A film is laminated to the surface of the fibrous substrate. The film comprises a biodegradable polymer. The biodegradable polymer, for instance, can comprise a polysaccharide ester polymer, such as a cellulose ester polymer. The film can also contain a plasticizer. An adhesive composition is optionally positioned between the surface of the fibrous substrate and the film. The adhesive composition bonds the film to the fibrous substrate. The adhesive composition, similar to the film, can also be biodegradable.

In one aspect, the present disclosure is directed to a method of thermoforming a film to a substrate. The method includes positioning a substrate within a substrate holder. The substrate defines a substrate surface. A film is positioned relative to the substrate surface and to a heating element. For example, the film can be positioned between the substrate surface and the heating element. The film and the substrate can form a film-substrate cavity between the film and the substrate. The film can comprise a biodegradable and/or paper recyclable polymer, such as a cellulose ester polymer.

Heat is generated by the heating element such that the heat from the heating element increases the temperature of the film. The heat from the heating element increases the temperature of the film to a forming temperature range where the film has been softened. While the film is within the forming temperature range, a suction force is applied to the film through the substrate and the substrate holder. The suction force manipulates the film such that the film contacts at least a portion of the substrate surface. In one aspect, the heating element continues to heat the film as the film is laminated to the substrate. During the process, the film is heated and softened so that the film will laminate to the substrate without heating the film to a temperature that will damage the film or cause the film to degrade. Through the process, the film conforms to at least a portion of the substrate surface and becomes laminated to the substrate to form a consolidated article.

The film not only comprises a biodegradable polymer, such as a cellulose ester polymer, but can also be relatively thin. The film can have a thickness, for instance, of less than about 100 microns.

### BRIEF DESCRIPTION OF THE DRAWINGS

A full and enabling disclosure of the present disclosure is set forth more particularly in the remainder of the specification, including reference to the accompanying figure, in which:

FIG. 1 illustrates a cross-sectional view of one embodiment of a substrate in accordance with the present disclosure;

FIG. 2 illustrates a cross-sectional view of one embodiment of a substrate holder in accordance with the present disclosure;

FIG. 3 illustrates a cross-sectional view of one embodiment of a substrate positioned in a substrate holder in accordance with the present disclosure;

FIG. 4 illustrates a schematic view of one embodiment of a system for laminating a film to a substrate in accordance with the present disclosure;

FIG. 5 illustrates a schematic view of another embodiment of a system for laminating a film to a substrate in accordance with the present disclosure;

FIG. 6 illustrates a schematic view of a further embodiment of a system for laminating a film to a substrate in accordance with the present disclosure; and

FIG. 7 illustrates a cross-sectional view of an article in accordance with the present disclosure.

Repeat use of reference characters in the present specification and drawings is intended to represent the same or analogous features or elements of the present invention.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to an article laminated with a thermoformed film and related systems and methods. The article may comprise a substrate and a film layer. The article and/or the film layer may comprise home compostable, industrially compostable, biodegradable, and/or paper recyclable materials. In this respect, in one aspect, an article formed in accordance with the present disclosure may be home compostable, industrially compostable, biodegradable, and/or paper recyclable. Notably, the utilization of a film layer may be particularly advantageous. For instance, an article laminated with a film layer may be water resistant, water impermeable, grease resistant, liquid resistant, and/or liquid impermeable.

Articles made according to the present disclosure have numerous and diverse uses and applications. Of particular advantage, the article may be completely safe for contact with food and beverages. One particular problem faced in the past was designing a biodegradable and/or compostable/paper recyclable food container or article that could be used to store frozen food and also be used to heat the food, such as in a microwave oven. In the past, these types of containers were typically made from petroleum-based plastics that were discarded after a single use and not recycled. As an alternative to plastic containers, those skilled in the art have also suggested making the food containers from pulp fibers. In the past, however, these containers were still laminated to a crosslinked polyethylene film, which prevented the container from entering the paper recycle stream or being compostable. The present disclosure solves the above problem and provides an article that can not only be used to hold food when frozen but also can be rapidly thawed in a microwave or oven while still being made from biodegradable/paper recyclable materials. Articles made according to the present disclosure, for instance, can be placed in the recycle stream and can be compostable. Further, the articles of the present disclosure can be frozen with a food product and rapidly heated without delaminating, disfiguring, or degrading.

In the past, fossil-based polymers were traditionally utilized to form containers having water resistance and/or grease resistance. Fossil-based polymers generally can be heated to high temperatures without the risk of formation of bubbles and/or defects. Further, fossil-based polymers generally can be heated to high temperatures without the occurrence of film-sag. Indeed, fossil-based polymers generally can be heated to temperatures well above the temperatures required for forming the fossil based polymers to an article. Biodegradable polymers, however, can be temperature sensitive. In accordance with the present disclosure, as will be described in greater detail below, a film comprised of a biodegradable (non-fossil based) polymer, particularly a relatively thin film, is heated within a selectively chosen forming temperature range to ensure that bubbles, foaming, and/or film sag do not occur. Further, heat can be maintained on the film through the entire laminating process. Further, other factors such as suction force, heating cycle time, the composition of the biodegradable polymer and/or a paper recyclable polymer, the temperature of one or more heating elements, the draw ratio, and the thickness of the film can be controlled for minimizing or preventing degradation of the film during the process. In this regard, in one aspect, products can be made according to the present disclosure that do not contain any fossil-based polymers, such as polyolefins.

Articles formed in accordance with the present disclosure may have a three-dimensional shape. For instance, an article formed in accordance with the present disclosure may have a circular, rectangular, triangular, or trapezoidal three-dimensional shape.

Articles made in accordance with the present disclosure can be used in all different types of applications. Notably, any component of an article formed in accordance with the present disclosure may be formed from materials that meet all of the requirements of 21 CFR 175.105 and of 21 CFR 175.125, meaning that the article is food contact compliant.

It should be understood that throughout the entirety of this specification, each numerical value (e.g., weight percentage, concentration) disclosed should be read as modified by the term “about” (unless already expressly so modified) and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the endpoints and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value.

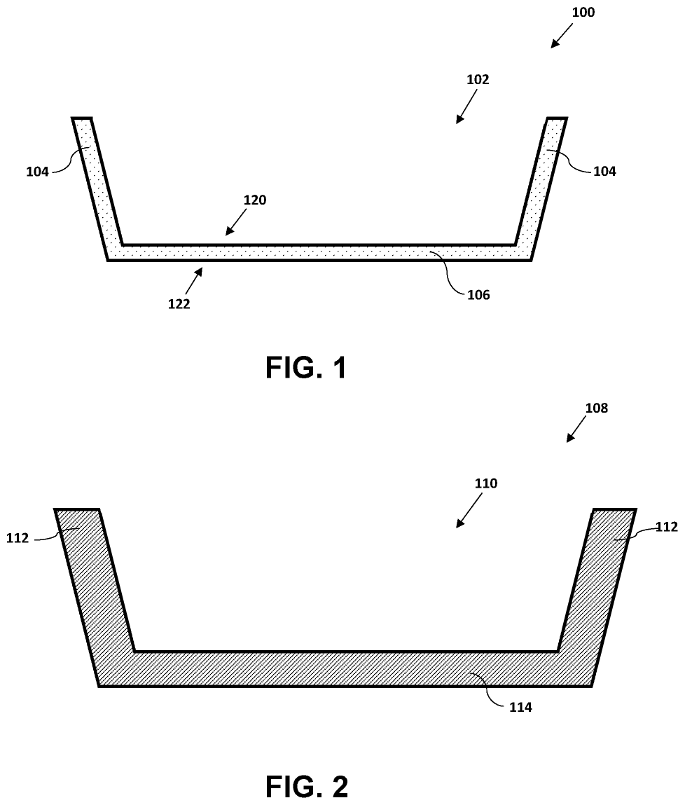

As illustrated in FIG. 1, and as previously disclosed herein, an article formed in accordance with the present disclosure may comprise a substrate 100. It should be understood that FIG. 1 is a cross-sectional view in which a side wall of a trapezoidal substrate 100 is not illustrated. The substrate 100 may have a three-dimensional shape. In general, a substrate 100 may comprise one or more substrate walls. In this respect, a substrate 100 may comprise one or more substrate side walls 104, a substrate bottom wall 106, a substrate top wall, or a combination thereof. The substrate 100 may comprise an interior surface 120 and an exterior surface 122. The interior surface 120 may define a substrate cavity 102.

In one aspect, the substrate 100 may be permeable to a gas (e.g., air), porous, and/or have one or more perforations. For instance, the substrate 100 can be naturally permeable. Alternatively, the substrate 100 may have one or more perforations in one or more substrate side walls 104, a substrate bottom wall 106, a substrate top wall, or a combination thereof. The one or more perforations of a substrate 100 may allow for the passage of a gas, such as air, through one or more of the respective perforations. In one aspect, one or more perforations may be located on a substrate 100 at the interface of two substrate side walls 104, at the interface of a substrate side wall 104 and a substrate bottom wall 106, at the interface of a substrate side wall 104 and a substrate top wall, or a combination thereof. In this respect, in one aspect, one or more perforations may be present on a substrate 100 at the edge formed by two walls of a substrate 100. Generally, one or more perforations may have a selectively chosen geometry. For instance, one or more perforations may be rectangular, circular, triangular, or a combination thereof.

The substrate 100 may be made from and/or comprise any suitable material, such as a fibrous material. The fibrous material may be biodegradable and/or paper recyclable. In one aspect, the substrate 100 may comprise a paper, a paperboard, a cardboard, a particle board, a wood, and the like. In one aspect, the substrate 100 may comprise organic fibers, such as plant fibers. Notably, in one aspect, the substrate 100 is formed from pulp fibers. As used herein, “pulp fibers” refer to delignified fibers that have undergone a pulping process, such as in a digester. The pulp fibers, for instance, may comprise wood pulp fibers. Wood pulp fibers include softwood fibers, hardwood fibers, or combinations thereof.

Other fibers that may be present within the substrate 100 include cotton fibers, linen fibers, regenerated cellulose fibers, such as rayon fibers or viscose fibers, recycled textile fibers, and the like. In one embodiment, the substrate 100 may contain bast fibers either alone or in combination with wood pulp fibers. Bast fibers that may be present in the substrate 100 include flax fibers, sugarcane fibers, bamboo fibers, hemp fibers, abaca fibers, kozo fibers, fibers from ground nutshells, mixtures thereof, and the like. In still another aspect, the substrate 100 may contain corn husk fibers.

When formed partially or exclusively from pulp fibers, particularly wood pulp fibers, the substrate 100 can have integrity through hydrogen bonding. In one aspect, a binder may be added during formation of the substrate 100 in order to increase integrity. Binders that may be incorporated into the substrate 100 include all different types of natural gums. Natural gums that may be used include guar gums, gum arabic, alginate gums, and the like. Other binders that may be used include starch, polyvinyl alcohol, polyglycolic acid, and mixtures thereof.

In one aspect, the binder may be a biodegradable polymer, such as a biodegradable aliphatic polyester. Biodegradable polyesters include, for instance, polylactic acid, poly-E-caprolactone, polyhydroxybutyrate, poly(3-hydroxyvalerate), polybutylene adipate succinate, and mixtures thereof.

When present, one or more binders may be contained in the substrate 100 in an amount less than about 5% by weight, such as in an amount less than about 3.5% by weight, such as in an amount less than about 3% by weight, such as in an amount less than about 2.5% by weight, and generally in an amount greater than about 0.1% by weight, such as in an amount greater than about 0.5% by weight, such as in an amount greater than about 1% by weight.

The substrate 100 may be made using various different processes. In one aspect, the substrate 100 may be compression molded. The substrate 100, for instance, may be compression molded using a wet or aqueous slurry of the materials or may be formed in an airlaid process. When formed in an airlaid process, a fluff pulp material may be placed in a mold and compacted.

As further illustrated in FIG. 1, and as previously disclosed herein, a substrate 100 may comprise a substrate cavity 102. In this respect, a substrate 100 and/or one or more components thereof may define a substrate cavity 102. Notably, one or more substrate side walls 104 and/or a substrate bottom wall 106 may define a substrate cavity 102. In general, the substrate cavity 102 may have any shape and/or size. For instance, the substrate cavity 102 may be cylindrical, triangular, trapezoidal, or rectangular. In this respect, in one aspect, one or more substrate walls (e.g., one or more substrate side walls 104, a substrate bottom wall 106) of the substrate 100 may form a cylindrical, triangular, trapezoidal, or rectangular substrate cavity 102. Generally, the substrate cavity 102 is three-dimensional.

In general, as illustrated in FIG. 2, a method of forming an article in accordance with the present disclosure and/or a system for forming an article in accordance with the present disclosure may include a substrate holder 108. It should be understood that FIG. 2 is a cross-sectional view in which a substrate holder side wall of a trapezoidal substrate holder 108 is not illustrated. In one aspect, the substrate holder 108 may be a mold. The substrate holder 108 can be made from any suitable material, such as aluminum. In one aspect, a substrate holder 108 may include passageways or perforations for allowing gases (e.g., air) to pass through the substrate holder 108. In one aspect, a substrate holder 108 may be permeable to a gas (e.g., air). In general, a substrate holder 108 may comprise one or more substrate holder walls. In this respect, a substrate holder 108 may comprise one or more substrate holder side walls 112 and/or a substrate holder bottom wall 114.

As further illustrated in FIG. 2, a substrate holder 108 may comprise a substrate holder cavity 110. In this respect, a substrate holder 108 may define a substrate holder cavity 110. Notably, one or more substrate holder side walls 112 and/or a substrate holder bottom wall 114 may define a substrate holder cavity 110. In general, the substrate holder cavity 110 may have any shape and/or size. For instance, the substrate holder cavity 110 may be cylindrical, triangular, trapezoidal, or rectangular. In this respect, in one aspect, one or more walls (e.g., one or more substrate holder side walls 112, a substrate holder bottom wall 114) of the substrate holder 108 may form and/or define a cylindrical, triangular, trapezoidal, or rectangular substrate holder cavity 110. Notably, in one aspect, the substrate holder cavity 110 may be complementary to the shape of the substrate 100.

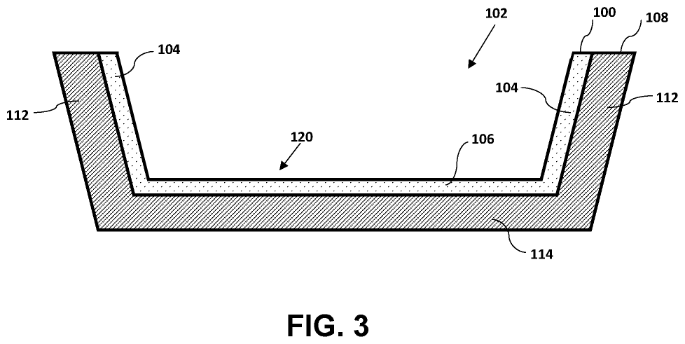

In general, as illustrated in FIG. 3, the method of forming an article in accordance with the present disclosure may include the positioning of a substrate 100 in a substrate holder 108. It should be understood that FIG. 3 is a cross-sectional view in which a side wall of a trapezoidal substrate 100 and a side wall of a trapezoidal substrate holder 108 are not illustrated. As previously disclosed herein, and as illustrated in FIG. 3, in one aspect, the substrate holder cavity 110 may be complementary to the shape of the substrate 100.

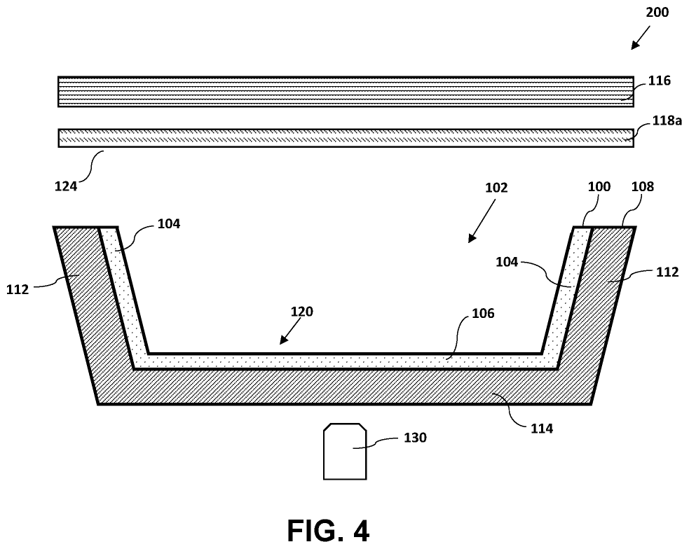

In general, FIG. 4 illustrates one aspect of a system 200 for thermoforming a film 118a to a substrate 100. It should be understood that FIG. 4 is a cross-sectional view in which a side wall of a trapezoidal substrate 100 and a side wall of a trapezoidal substrate holder 108 are not illustrated. In general, a system 200 may comprise one or more heating elements 116, a film 118a, a substrate 100, a substrate holder 108, or a combination thereof.

In one aspect, one or more heating elements 116 may be positioned relative to a film 118a. Further, in one aspect, one or more heating elements 116 may be positioned above a film 118a, a substrate 100, a substrate holder 108, or a combination thereof. In general, the one or more heating elements 116 may include one or more radiant heating elements. Notably, the one or more heating elements 116 elements may generate heat (e.g., radiant heat) before, during, and/or after any of the process steps disclosed herein. In this respect, in one aspect, the one or more heating elements 116 may continuously generate heat (e.g., radiant heat) as the film 118a is contacted and formed to a substrate 100. In another aspect, the one or more heating elements 116 may intermittently generate heat (e.g., radiant heat) as the film 118a is contacted and formed to a substrate 100. In general, the one or more heating elements 116 may generate heat to increase and/or maintain the temperature of a film 118a to a temperature within a forming temperature range and/or to a temperature at the end points of a forming temperature range without overheating the film to a temperature that may cause defects or degradation.

In one aspect, the one or more heating elements 116 may include one or more electric radiant heaters, one or more ceramic radiant heaters, one or more infrared tube heaters (e.g., one or more quartz tube heaters), or a combination thereof. The one or more heating elements 116 may operate at a temperature of from about 200° C. to about 350° C., including all increments of 1° C. therebetween. For instance, one or more heating elements 116 may have a temperature of about 200° C. or more, such as about 210° C. or more, such as about 220° C. or more, such as about 230° C. or more, such as about 240° C. or more, such as about 250° C. or more, such as about 260° C. or more, such as about 270° C. or more, such as about 280° C. or more, such as about 290° C. or more, such as about 300° C. or more, such as about 310° C. or more, such as about 320° C. or more, such as about 330° C. or more, such as about 340° C. or more. Generally, the one or more heating elements 116 may have a temperature of about 350° C. or less, such as about 340° C. or less, such as about 330° C. or less, such as about 320° C. or less, such as about 310° C. or less, such as about 300° C. or less, such as about 290° C. or less, such as about 280° C. or less, such as about 270° C. or less, such as about 260° C. or less, such as about 250° C. or less, such as about 240° C. or less, such as about 230° C. or less, such as about 220° C. or less, such as about 210° C. or less.

Generally, one or more heating elements 116 may heat or increase the temperature of a film 118a for a selectively chosen period of time. As used herein, “heating cycle time” refers to the period of time that the film is heated by one or more heating elements 116. In one aspect, one or more heating elements 116 may have a heating cycle time of from about 0.01 seconds to about 40 seconds, including all increments of 0.01 seconds therebetween. For instance, one or more heating elements 116 may have a heating cycle time of about 0.01 seconds or more, such as about 1 second or more, such as about 2 seconds or more, such as about 3 seconds or more, such as about 4 seconds or more, such as about 5 seconds or more, such as about 6 seconds or more, such as about 7 seconds or more, such as about 8 seconds or more, such as about 9 seconds or more, such as about 10 seconds or more, such as about 12 seconds or more, such as about 14 seconds or more, such as about 16 seconds or more, such as about 18 seconds or more, such as about 20 seconds or more, such as about 22 seconds or more, such as about 24 seconds or more, such as about 26 seconds or more, such as about 28 seconds or more. In general, one or more heating elements 116 may have a heating cycle time of about 40 seconds or less, such as about 35 seconds or less, such as about 30 seconds or less, such as about 28 seconds or less, such as about 26 seconds or less, such as about 24 seconds or less, such as about 22 seconds or less, such as about 20 seconds or less, such as about 18 seconds or less, such as about 16 seconds or less, such as about 14 seconds or less, such as about 12 seconds or less, such as about 10 seconds or less, such as about 8 seconds or less, such as about 6 seconds or less, such as about 4 seconds or less, such as about 2 seconds or less.

As previously disclosed herein, in one aspect, one or more heating elements 116 may be positioned relative to a film 118a. In general, one or more heating elements 116 may be spaced from a film 118a at a distance from about 10 mm to about 300 mm, including all increments of 1 mm therebetween. For instance, one or more heating elements 116 may be spaced from a film 118a at a distance of about 10 mm or more, such as about 20 mm or more, such as about 40 mm or more, such as about 60 mm or more, such as about 80 mm or more, such as about 100 mm or more, such as about 120 mm or more, such as about 140 mm or more, such as about 160 mm or more, such as about 180 mm or more, such as about 200 mm or more. In general, one or more heating elements 116 may be spaced from a film 118a at a distance of about 300 mm or less, such as about 250 mm or less, such as about 200 mm or less, such as about 180 mm or less, such as about 160 mm or less, such as about 140 mm or less, such as about 120 mm or less, such as about 100 mm or less, such as about 80 mm or less, such as about 60 mm or less, such as about 40 mm or less, such as 20 mm or less.

As previously disclosed herein, in one aspect, the system 200 may comprise a film 118a. In general, the film 118a may be positioned relative to one or more heating elements 116, a substrate 100, a substrate holder 108, or a combination thereof.

In general, a film 118a may have a thickness of from about 5 microns to about 1000 microns, including all increments of 1 micron therebetween. In one aspect, a relatively thin film is used during the process. Thinner films can be heated faster to a more uniform temperature. For instance, the film can have a thickness of less than about 200 microns, such as about 180 microns or less, such as about 160 microns or less, such as about 140 microns or less, such as about 120 microns or less, such as about 100 microns or less, such as about 90 microns or less, such as about 80 microns or less, such as about 70 microns or less, such as about 60 microns or less, such as about 50 microns or less, such as about 40 microns or less, such as about 30 microns or less, such as about 20 microns or less. The film 118a may have a thickness of about 5 microns or more, such as about 10 microns or more, such as about 15 microns or more, such as about 20 microns or more, such as about 30 microns or more, such as about 40 microns or more, such as about 50 microns or more, such as about 60 microns or more, such as about 70 microns or more, such as about 80 microns or more, such as about 90 microns or more. In one aspect, a film is used that is as thin as possible while still having sufficient strength to withstand the laminating process.

In some aspects, the film 118a can first be produced and then wound into a roll and/or cut into sheets. In one aspect, a roll can be unwound and fed into a process for laminating the film 118a to the substrate 100. In another aspect, a cut sheet of film can be fed into a process for laminating the film 118a to the substrate 100.

Generally, the film 118a may comprise a polymer composition. In one aspect, the film 118a may comprise a home compostable, industrially compostable, biodegradable, and/or paper recyclable polymer composition, such as any suitable bio-based polymer. For instance, in one aspect, the film 118a may comprise a polymer composition comprising a polysaccharide ester polymer, such as a cellulose ester polymer.

In one aspect, the polymer composition may comprise a cellulose ester polymer combined with at least one plasticizer. The polymer composition can optionally contain various other additives and ingredients. The polymer composition can be particularly formulated to produce films having excellent optical properties. Of particular advantage, the optical properties of the films can be retained in the three-dimensional articles produced according to the present disclosure. In this respect, a film layer formed in accordance with the present disclosure may have excellent optical properties.

In general, any suitable cellulose ester polymer can be incorporated into the polymer composition. In one aspect, the cellulose ester polymer is a cellulose acetate. Cellulose acetate may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses of the Miscanthus family), bacterial cellulose, seed hulls (e.g., soybeans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification.

Cellulose esters suitable for use in producing the composition of the present disclosure may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof.

The cellulose acetate used in the composition may be cellulose diacetate or cellulose triacetate. In one embodiment, the cellulose acetate comprises primarily cellulose diacetate. For example, the cellulose acetate can contain less than 1% by weight cellulose triacetate, such as less than about 0.5% by weight cellulose triacetate. Cellulose diacetate can make up greater than 90% by weight of the cellulose acetate, such as greater than about 95% by weight, such as greater than about 98% by weight, such as greater than about 99% by weight of the cellulose acetate.

In general, the cellulose acetate can have a molecular weight of greater than about 10,000, such as greater than about 20,000, such as greater than about 30,000, such as greater than about 40,000, such as greater than about 50,000. The molecular weight of the cellulose acetate is generally less than about 300,000, such as less than about 250,000, such as less than about 200,000, such as less than about 150,000, such as less than about 100,000, such as less than about 90,000, such as less than about 70,000, such as less than about 50,000. The molecular weights identified above refer to the number average molecular weight. Molecular weight can be determined using gel permeation chromatography using a polystyrene equivalent or standard.

The biodegradation of the cellulose ester polymer can depend upon various factors including the degree of substitution. The degree of substitution of the cellulose ester can be measured, for example, using ASTM Test 871-96 (2010). The cellulose acetate polymer incorporated into the polymer composition can generally have a degree of substitution of greater than about 2.0, such as greater than about 2.1, such as greater than about 2.2, such as greater than about 2.3. The degree of substitution is generally less than about 3.3, such as less than about 3.0, such as less than about 2.8, such as less than about 2.6. In one aspect, for instance, the cellulose acetate polymer has a degree of substitution of from about 2.1 to about 2.8, including all increments of 0.1 therebetween.

The cellulose ester polymer or cellulose acetate can have an intrinsic viscosity of generally greater than about 0.5 dL/g, such as greater than about 0.8 dL/g, such as greater than about 1 dL/g, such as greater than about 1.2 dL/g, such as greater than about 1.4 dL/g, such as greater than about 1.6 dL/g. The intrinsic viscosity is generally less than about 2 dL/g, such as less than about 1.8 dL/g, such as less than about 1.7 dL/g, such as less than about 1.65 dL/g. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$IV = ( \frac{k}{c} ) ( antilog ( ( log {n}_{ret} ) / k ) - 1 ) \qquad Equation 1$$

$$where {n}_{rel} = ( \frac{{t}_{1}}{{t}_{2}} ) ,$$

t₁=the average flow time of solution (having cellulose ester) in seconds, t₂=the average flow times of solvent in seconds, k=solvent constant (10 for 98/2 wt/wt acetone/water), and c=concentration (0.200 g/dL).

The cellulose acetate may be present in a polymer composition used to produce a film 118a in an amount greater than about 20% by weight, such as in an amount greater than about 25% by weight, such as in an amount greater than about 30% by weight, such as in an amount greater than about 35% by weight, such as in an amount greater than about 40% by weight, such as in an amount greater than about 45% by weight, such as in an amount greater than about 50% by weight, such as in an amount greater than about 55% by weight, such as in an amount greater than about 62% by weight, such as in an amount greater than about 65% by weight. The cellulose acetate may be present in a polymer composition in an amount less than about 85% by weight, such as in an amount less than about 82% by weight, such as in an amount less than about 80% by weight, such as in an amount less than about 74% by weight, such as in an amount less than about 71% by weight.

The cellulose ester polymer can be combined with one or more plasticizers. Plasticizers particularly well suited for use in the polymer composition include polyalkylene glycols and/or polyglycerides. For example, the plasticizer can comprise a monoglyceride, a diglyceride, a triglyceride (e.g., triacetin), or polyethylene glycol. In one particular aspect, the plasticizer comprises 1,2,3-triacetylglycol. In other aspects, however, the plasticizer can be a diacetylglycol or a monoacetylglycol alone or in combination with a triacetylglycol. Other suitable plasticizers include tris(chloroisopropyl)phosphate, tris(2-chloro-1-methylethyl)phosphate, triethyl citrate, acetyl triethyl citrate, glycerin, or mixtures thereof.

Other examples of plasticizers include, but are not limited to, trimethyl phosphate, triethyl phosphate, tributyl phosphate, triphenyl phosphate, acetyl tributyl citrate, tributyl-o-acetyl citrate, dibutyl tartrate, ethyl o-benzoylbenzoate, n-ethyltoluenesulfonamide, o-cresyl p-toluenesulfonate, aromatic diol, substituted aromatic diols, aromatic ethers, tripropionin, tribenzoin, glycerin, glycerin esters, glycerol tribenzoate, glycerol acetate benzoate, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrrolidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., gamma.-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

In one aspect, a carbonate ester may serve as a plasticizer. Exemplary carbonate esters may include, but are not limited to, propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, phenyl tridecyl carbonate, and the like, and any combination thereof.

In still another aspect, the plasticizer can be a polyol benzoate. Exemplary polyol benzoates may include, but are not limited to, glyceryl tribenzoate, propylene glycol dibenzoate, diethylene glycol dibenzoate, dipropylene glycol dibenzoate, triethylene glycol dibenzoate, sucrose benzoate, polyethylene glycol dibenzoate, neopentylglycol dibenzoate, trimethylolpropane tribenzoate, trimethylolethane tribenzoate, pentaerythritol tetrabenzoate, sucrose benzoate (with a degree of substitution of 1-8), and combinations thereof. In some instances, tribenzoates like glyceryl tribenzoate may be preferred. In some instances, polyol benzoates may be solids at 25° C. and a water solubility of less than 0.05 g/100 mL at 25° C.

In one aspect, the plasticizer can be a sulfonamide plasticizer. For instance, the plasticizer can be a toluene sulfonamide plasticizer. The toluene sulfonamide plasticizer can have a melting point of less than about 120° C., such as less than about 115° C. The sulfonamide plasticizer can be combined with any of the other plasticizers described above.

In one aspect, the plasticizer is phthalate-free. In fact, the polymer composition can be formulated to be phthalate-free. For instance, phthalates can be present in the polymer composition in an amount of about 0.1% or less, such as in an amount of about 0.001% or less.

In general, one or more plasticizers may be present in the polymer composition in an amount from about 5% to about 48% by weight, such as from about 15% to about 48% by weight, such as in an amount from about 18% to about 36% by weight. In one aspect, one or more plasticizers may be present in the polymer composition in an amount of greater than about 20% by weight, such as in an amount greater than about 23% by weight, such as in an amount greater than about 25% by weight, such as in an amount greater than about 27% by weight, such as in an amount greater than about 29% by weight, and generally in an amount less than about 43% by weight, such as in an amount less than about 36% by weight.

Antioxidants may, in some embodiments, mitigate oxidation and/or chemical degradation of a cellulose ester plastic described herein during storage, transportation, and/or implementation. Antioxidants suitable for use in conjunction with a cellulose ester plastic described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In one aspect, the antioxidant incorporated into the polymer composition is a phosphite. For example, the antioxidant can be a polyphosphite, such as a diphosphite. In one particular embodiment, for instance, the antioxidant incorporated into the polymer composition is Bis(2,4-dicumylphenyl) pentaerythritol diphosphite.

In some embodiments, antioxidants suitable for use in conjunction with a cellulose ester plastic described herein may be food-grade antioxidants. Examples of food-grade antioxidants may, in some embodiments, include, but are not limited to, ascorbic acid, vitamin A, tocopherols, tocopherol esters, beta-carotene, flavonoids, BHT, BHA, hydroquinone, phosphites, and the like, and any combination thereof.

Any of the above antioxidants, including the phosphites described above, can be incorporated into the polymer composition generally in an amount greater than about 0.001% by weight, such as in an amount greater than about 0.01% by weight, such as in an amount greater than about 0.05% by weight, such as in an amount greater than about 0.08% by weight, and generally in an amount less than about 0.35% by weight, such as in an amount less than about 0.3% by weight, such as in an amount less than about 0.25% by weight, such as in an amount less than about 0.2% by weight, such as in an amount less than about 0.15% by weight, such as in an amount less than about 0.1% by weight. In one embodiment, the polymer composition contains a phosphite antioxidant alone or in combination with one of the other antioxidants described above.

The polymer composition of the present disclosure may include a polycarboxylic acid. The polycarboxylic acid, for instance, can be a dicarboxylic acid or a tricarboxylic acid. In one aspect, the polycarboxylic acid can be citric acid. The polycarboxylic acid, such as citric acid, can be present in the polymer composition in an amount greater than about 0.001% by weight, such as in an amount greater than about 0.005% by weight, such as in an amount greater than about 0.01% by weight, such as in an amount greater than about 0.03% by weight. One or more polycarboxylic acids can be present in the polymer composition generally in an amount less than about 0.1% by weight, such as in an amount less than about 0.08% by weight, such as in an amount less than about 0.06% by weight, such as in an amount less than about 0.04% by weight.

In addition to a cellulose ester polymer, one or more plasticizers, one or more antioxidants, and one or more polycarboxylic acids, the polymer composition can also contain various other additives and ingredients. For example, the polymer composition can also contain an odor masking agent. The odor masking agent, for instance, can absorb odors and/or produce its own odor. Masking agents that may be incorporated into the composition include zeolites, particularly synthetic zeolites, fragrances, and the like.

Other additives and ingredients that may be included in the polymer composition include pigments, lubricants, softening agents, antibacterial agents, antifungal agents, preservatives, flame retardants, and combinations thereof. Each of the above additives can generally be present in the polymer composition in an amount of about 5% or less, such as in an amount of about 2% or less, and generally in an amount of about 0.1% or greater, such as in an amount of about 0.3% or greater.

Flame retardants suitable for use in conjunction with a cellulose ester plastic described herein may, in some embodiments, include, but are not limited to, silica, metal oxides, phosphates, catechol phosphates, resorcinol phosphates, borates, inorganic hydrates, aromatic polyhalides, and the like, and any combination thereof.

Antifungal and/or antibacterial agents suitable for use in conjunction with a cellulose ester plastic described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Preservatives suitable for use in conjunction with a cellulose ester plastic described herein may, in some embodiments, include, but are not limited to, benzoates, parabens (e.g., the propyl-4-hydroxybenzoate series), and the like, and any combination thereof.

Pigments and dyes suitable for use in conjunction with a cellulose ester plastic described herein may, in some embodiments, include, but are not limited to, solvent-based dyes, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74 L), and the like, any derivative thereof, and any combination thereof.

In some embodiments, pigments and/or dyes suitable for use in conjunction with a cellulose ester plastic described herein may be food-grade pigments and dyes. Examples of food-grade pigments and dyes may, in some embodiments, include, but are not limited to, plant dyes, vegetable dyes, titanium dioxide, and the like, and any combination thereof.

It should be understood that many of the above additives and ingredients are optional. For instance, in particular embodiments, there may be advantages to excluding certain materials from the polymer composition. For example, in one aspect, the polymer composition is formulated without containing any filler particles, particularly white filler particles.

The polymer composition can also be formulated without containing any tackifying resins. In still another aspect, the polymer composition can be free from any thermoplastic polymers except for the cellulose ester polymer. In one aspect, in addition to the cellulose ester polymer, the polymer composition contains other thermoplastic polymers in an amount less than about 15% by weight, such as in an amount less than about 10% by weight, such as in an amount less than about 3% by weight. In one embodiment, for instance, the cellulose ester polymer can be combined with other biodegradable polymers, such as polylactic acid, polycaprolactone, polyhydroxybutyrate, or mixtures thereof. In one particular aspect, the polymer composition only contains the cellulose ester polymer, one or more plasticizers, one or more antioxidants, and one or more polycarboxylic acids.

A film 118a can be made from the above described polymer composition using various methods and techniques. For instance, the film 118a can be formed through a casting process, can be extruded, or can be a blown film. In one embodiment, for instance, in order to form a film 118a, the cellulose ester polymer in powder or flake form and optionally a plasticizer and other ingredients are combined with a solvent and formed into a dope. The dope can then be used in a solvent casting process to form the film 118a.

In an alternative embodiment, the polymer composition is heated to a temperature and melt-extruded to form the film 118a. For example, the composition can be heated to a viscosity of from about 50,000 cp to about 200,000 cp, such as from about 80,000 cp to about 120,000 cp.

Any suitable extruder can be used in order to produce the film 118a. For example, an extruder may be a co-rotating twin screw extruder or alternatively can be a single screw extruder. During extrusion, the polymer composition can generally be heated to a temperature of from about 170° C. to about 235° C., such as from about 190° C. to about 220° C. In one aspect, the hot molten polymer is fed onto a polished metal band or drum with an extrusion die. Once on the band or drum, the film 118a can be cooled and peeled from the metal support.

If desired, the film 118a may be uniaxially stretched or biaxially stretched using any suitable method. For instance, the film can be stretched using a roll method or using a tenter frame. Stretching the film can thin the film and possibly improve the optical properties of the film. Generally, the draw ratio in the machine direction or the cross-machine direction is from about 0.1 to about 4, including all increments of 0.1 therebetween. Notably, as the draw ratio increases, an increase in thickness is preferable as a film with unsuitable thickness may burst when heated and applied to a substrate. The draw ratio may be about 0.1 or more, such as about 0.5 or more, such as about 1 or more, such as about 1.2 or more, such as about 1.4 or more, such as about 1.6 or more, such as about 1.8 or more, such as about 2 or more, such as about 2.2 or more, such as about 2.4 or more, such as about 2.6 or more, such as about 2.8 or more, such as about 3 or more. In general, the draw ratio may be about 4 or less, such as about 3.5 or less, such as about 3 or less, such as about 2.8 or less, such as about 2.6 or less, such as about 2.4 or less, such as about 2.2 or less, such as about 2 or less, such as about 1.8 or less, such as about 1.6 or less, such as about 1.4 or less, such as about 1.2 or less, such as about 1 or less, such as about 0.5 or less.

Films made in accordance with the present disclosure can have excellent optical properties. These optical properties can be retained after the film 118a has been laminated to a substrate 100 to form a substrate 100 with a film layer. Notably, films made according to the present disclosure can have relatively low haze when measured according to ASTM Test D1003 (2013).

Haze can be measured using any acceptable instrument according to the ASTM Test including, for instance, a BYK Gardner Haze-Gard 4725 instrument. Haze can be measured on a test plaque, on a film 118a made according to the present disclosure, or on the final article. The test plaque can have any suitable thickness, such as 1 mm, 2 mm, 3 mm, or 4 mm. When any of the above samples are tested, the haze of the sample or article can generally be less than about 10%, such as less than about 8%, such as less than about 5%, such as less than about 3%, such as less than about 2%. In one aspect, the haze can be less than 1%, such as less than about 0.8%, such as less than about 0.5%, such as less than about 0.4%, such as less than about 0.3%, such as less than about 0.2%.

In addition to low haze, films and articles made according to the present disclosure can also have high transmission rates, whether the article is translucent (e.g. is a shade of color containing one or more coloring agents) or transparent. For example, when measured for transmission properties at a wavelength of from about 380 nm to about 780 nm, a film or article can display a transmission of greater than about 70%, such as greater than about 75%, such as greater than about 80%, such as greater than about 85%, such as greater than about 90%, such as greater than about 95%.

In general, as previously disclosed herein, a film 118a may be heated with one or more heating elements 116. In this respect, one or more heating elements 116 may increase the temperature of a film 118a. In one aspect, one or more heating elements 116 may increase the temperature of a film 118a to a temperature of a forming temperature range. In this respect, one or more heating elements 116 may increase the temperature of a film 118a to a temperature within a forming temperature range and/or to a temperature at the end points of a forming temperature range. As used herein, the “forming temperature range” is a temperature range at which a film 118a is softened and capable of conforming to a surface of a substrate. In general, the operating temperature of one or more heating elements 116 may maintain a film 118a within a forming temperature range through the entire process of laminating the film to the substrate. Notably, the operating temperature of one or more heating elements 116 may be constant or vary during any of the process steps disclosed herein. Generally, a varying operating temperature of the one or more heating elements 116 may be advantageously utilized to maintain a film 118a at a forming temperature range as the distance from the one or more heating elements 116 to the film 118a increases. Further, a varying operating temperature of the one or more heating elements 116 may be advantageously utilized to maintain a film 118a at a forming temperature range as a suction force is applied to the film 118a.

Notably, the forming temperature range may be from about 150° C. to about 220° C., including all increments of 1° C. therebetween. For instance, the forming temperature range may have a minimum of about 150° C. or more, such as about 160° C. or more, such as about 170° C. or more, such as about 180° C. or more, such as about 190° C. or more, such as about 200° C. or more, such as about 210° C. or more. In general, the forming temperature range may have a maximum of about 220° C. or less, such as about 210° C. or less, such as about 200° C. or less, such as about 190° C. or less, such as about 180° C. or less, such as about 170° C. or less, such as about 160° C. or less. In one preferred aspect, the forming temperature range may be from about 170° C. to about 190° C.

Generally, the forming temperature of the film 118a may be at any temperature within a forming temperature range including the end points of a forming temperature range. In this respect, the forming temperature of the film 118a may be from about 150° C. to about 220° C., including all increments of 1° C. therebetween. For instance, the forming temperature may be about 150° C. or more, such as about 160° C. or more, such as about 170° C. or more, such as about 180° C. or more, such as about 190° C. or more, such as about 200° C. or more, such as about 210° C. or more. In general, the forming temperature may be about 220° C. or less, such as about 210° C. or less, such as about 200° C. or less, such as about 190° C. or less, such as about 180° C. or less, such as about 170° C. or less, such as about 160° C. or less. Notably, incomplete forming of a film 118a to a substrate 100 may occur if the film temperature is too low for the respective film 118a. Further, bubbles and/or foaming of a film 118a may occur if the film temperature is too high for the respective film 118a.

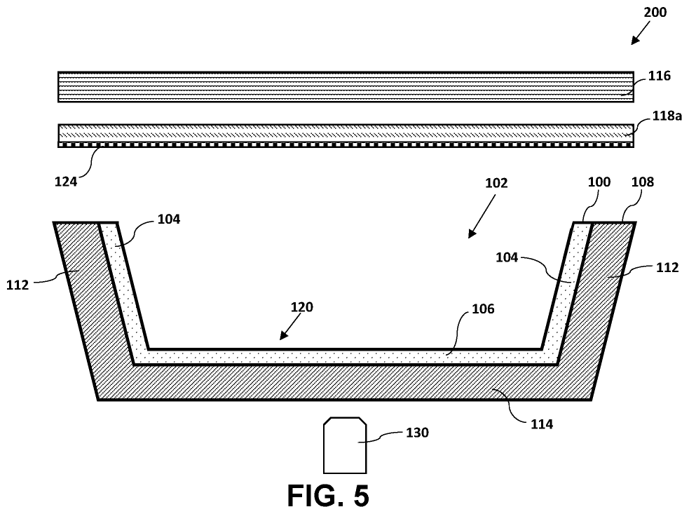

As illustrated in FIG. 5, in one aspect, a film 118a may optionally be coated with an adhesive layer 124. It should be understood that FIG. 4 is a cross-sectional view in which a side wall of a trapezoidal substrate 100 and a side wall of a trapezoidal substrate holder 108 are not illustrated. The adhesive layer 124 can be made from any suitable adhesive composition. In one aspect, the adhesive composition used to produce the adhesive layer 124 is biodegradable. In one aspect, the adhesive composition used to produce the adhesive layer 124 is paper recyclable. In one aspect, the adhesive composition used to produce the adhesive layer 124 is compostable. The adhesive layer 124 may be positioned between a film 118a and the substrate 100 and may be used to bond the film 118a to a surface (e.g., the interior surface 120) of the substrate 100. Alternatively, the film 118a may be formulated or configured so as to bond with the substrate 100 without the use of an adhesive.

In one aspect, the adhesive layer 124 is made from a heat activated and/or a pressure sensitive adhesive composition with low tack properties. For example, the adhesive composition of the adhesive layer 124 can comprise a polyvinyl alcohol, a polybutylene succinate, and/or an acrylic polymer. The adhesive composition, for instance, can be an acrylic-based polymer such as an emulsion acrylic composition or a solvent acrylic composition.

In one embodiment, the adhesive composition can comprise a biodegradable gelatin. For example, the adhesive composition can comprise a water-based gelatin. Gelatin compositions, for instance, are completely biodegradable.

The adhesive composition can be coated on one side of the film 118a in order to produce the adhesive layer 124 using any suitable process or technique. For instance, the adhesive composition can be coated onto the film 118a using knife coating methods, slot-die coating, bar coating, or the like. In one application, the adhesive composition can be applied to one surface of the film 118a while the film 118a is at an elevated temperature and during formation of the film. In this manner, the heat of the film can be used to dry the coating on the film. In one aspect, an adhesive composition may be extruded on to the film 118a to form an adhesive layer 124. In one aspect, an adhesive composition and the film 118a may be coextruded such that an adhesive layer 124 is formed on the film 118a. In one aspect, an adhesive composition may be laminated to the film 118a to form an adhesive layer 124.

The thickness of the adhesive layer 124 is generally less than the thickness of the film 118a. For instance, the adhesive layer 124 can have a thickness of less than about 30 microns, such as less than about 20 microns, such as less than about 10 microns, such as less than about 8 microns, such as less than about 5 microns, such as less than about 4 microns, such as less than about 3 microns, such as less than about 2 microns, and generally greater than about 0.1 microns, such as greater than about 0.5 microns, such as greater than about 1 micron, such as greater than about 2 microns, such as greater than about 3 microns, such as greater than about 4 microns, such as greater than about 5 microns, such as greater than about 8 microns, such as greater than about 10 microns, such as greater than about 12 microns, such as greater than about 15 microns, such as greater than about 20 microns.

The adhesive layer 124 can be applied to either surface of the film 118a. When forming a cast film, the film 118a can, in one embodiment, include a side with a matte finish and a polished side having higher gloss characteristics. In one embodiment, the adhesive composition is applied to the polished side of the film 118a.

As previously disclosed herein, a substrate 100 may be air permeable, perforated, and/or porous. In one aspect, an air permeable, perforated, and/or porous substrate 100 may be utilized to assist in laminating the film 118a to a surface of the substrate 100. For instance, pressure may be applied to a film 118a and/or a suction force or vacuum may be applied to the film 118a. In this respect, the pressure applied to a film 118a and/or a suction force or vacuum applied to a film may maintain pressure between the film 118a and a surface (e.g., the interior surface 120) of the substrate 100. Generally, a pressure applied to a film 118a and/or a suction force or vacuum applied to a film may manipulate or move the film 118a. In one aspect, when a suction force from a vacuum is utilized, the flow of a gas (e.g., air) through a substrate 100 and/or substrate holder 108 may result in the manipulation or movement of the film 118a. In this respect, a suction force may be applied through a substrate 100 and/or a substrate holder 108. Notably, in one aspect, the substrate 100 and the substrate holder 108 may be permeable to air such that a suction force is applied by one or more suctions elements 130 through a substrate 100 and a substrate holder 108 to a film 118a.

In general, the manipulation or movement of the film 118a resulting from a suction force may bring at least a portion of the film 118a surface closer to at least a portion of a substrate surface, such as a portion of the interior surface 120 of the substrate 100. Notably, in one aspect, the manipulation or movement of the film 118a resulting from a suction force may result in the contact of at least a portion of a film surface to at least portion of a substrate surface, such as a portion of the interior surface 120 of the substrate 100. In this respect, the manipulation or movement of the film 118a resulting from a suction force may result in the contact of a film 118a and a substrate 100.

Generally, a film 118a may be maintained at a forming temperature range before, after, and/or during any of the process steps disclosed herein. For instance, a film 118a may be maintained at a forming temperature range while a suction force or vacuum is applied to a film 118a. In this respect, the temperature of a film 118a may be maintained at a forming temperature within a forming temperature range and/or at a forming temperature at the end points of a forming temperature range while a suction force or a vacuum is applied to the film 118a. Notably, if the temperature of the film 118a is too low, the film 118a may experience film bursting and/or stress whitening. It should be understood that the temperature of the film 118a may vary while the temperature of the film 118a is maintained at a forming temperature range. For instance, if the forming temperature range is about 170° C. to about 190° C., one or more heating elements 116 may ensure that the temperature of a film 118a is from about 170° C. to about 190° C. while a suction force or a vacuum is applied to the film 118a. In one aspect, a film 118a may be maintained at a specific forming temperature while a suction force or vacuum is applied to the film 118a. Notably, maintaining a film 118a at a forming temperature range while the film is contacted with and formed to a substrate 100 is particularly advantageous for the biodegradable and/or paper recyclable polymers of the present disclosure and allows laminates to be formed according to the present disclosure without defects or imperfections.

As further illustrated in FIG. 4, in one aspect, a system 200 may comprise one or more suction elements 130 configured to generate a suction force. In one aspect, after a film 118a is heated by one or more heating elements 116 and/or during the heating of a film 118a by one or more heatings elements 116, a suction force may be applied to the substrate holder 108, the substrate 100, and/or the film 118a. In this respect, if the substrate holder 108 and the substrate 100 are gas permeable, porous, and/or perforated, the suction force may be applied to the heated film 118a. Notably, in one aspect, the film 118a and the substrate holder 108 and/or the substrate 100 may form a cavity. The cavity formed between a film 118a and a substrate holder 108 and/or a substrate 100 refers to the volumetric space between the film 118a and the substrate holder 108 and/or the film 118a and the substrate 100. In one aspect, the cavity may comprise a gas, such as air. The size of the cavity may change during the application of a film 118a to a substrate 100. In one aspect, a suction force applied to a film 118a may evacuate or withdraw a gas (e.g., air) from the cavity. In one aspect, as a suction force is applied to a film 118a, the volume of the cavity may decrease. In this respect, in one aspect, a suction force may withdraw gas (e.g., air) from the cavity such that the volume of the cavity decreases. Notably, the withdrawal of a gas (e.g., air) from a cavity may result in a portion of a film surface moving closer to a portion of a substrate surface until the portion of the film surface contacts the portion of the substrate surface. In this respect, the withdrawal of a gas (e.g., air) from a cavity may decrease the distance from a film 118a to a substrate 100. The cavity formed between a film 118a and a substrate holder 108 may be referred to as the film-substrate holder cavity. The cavity formed between a film 118a and a substrate 100 may be referred to as the film-substrate cavity.

In general, the suction force or vacuum may be applied by one or more suction elements 130 to a film 118a, a substrate 100, and/or a substrate holder 108 at a pressure of about −0.1 bar to about −2 bar, including all increments of −0.1 bar. For instance, the suction force or vacuum may be applied by one or more suction elements 130 at a pressure of about −0.1 bar or less, such as about −0.2 bar or less, such as about −0.3 bar or less, such as about −0.4 bar or less, such as about −0.5 bar or less, such as about −0.6 bar or less, such as about −0.7 bar or less, such as about −0.8 bar or less, such as about −0.9 bar or less, such as about −1 bar or less, such as about −1.2 bar or less, such as about −1.4 bar or less, such as about −1.6 bar or less, such as about −1.8 bar or less. Generally, the suction force or vacuum may be applied by one or more suction elements 130 at a pressure of about −2 bar or more, such as about −1.8 bar or more, such as about −1.6 bar or more, such as about −1.4 bar or more, such as about −1.2 bar or more, such as about −1 bar or more, such as about −0.9 bar or more, such as about −0.8 bar or more, such as about −0.7 bar or more, such as about −0.6 bar or more, such as about −0.5 bar or more, such as about −0.4 bar or more, such as about −0.3 bar or more, such as about −0.2 bar or more.

The vacuum or suction force is generally applied for a time for a film 118a to assume the shape of a substrate 100 and to bond to the substrate 100. In one aspect, a vacuum or a suction force may be applied by one or more suction elements 130 for a vacuum duration of about 0.5 seconds to about 20 seconds, including all increments of 0.5 seconds therebetween. For instance, in one aspect, a vacuum or a suction force may be applied by one or more suction elements 130 for a period of time of about 0.5 seconds or more, such as about 1 second or more, such as about 2 seconds or more, such as about 3 seconds or more, such as about 4 seconds or more, such as about 5 seconds or more, such as about 6 seconds or more, such as about 7 seconds or more, such as about 8 seconds or more, such as about 9 seconds or more, such as about 10 seconds or more, such as about 12 seconds or more, such as about 15 seconds or more. In general, a vacuum or a suction force may be applied by one or more suction elements 130 for a period of time of about 20 seconds or less, such as about 15 seconds or less, such as about 12 seconds or less, such as about 10 seconds or less, such as about 9 seconds or less, such as about 8 seconds or less, such as about 7 seconds or less, such as about 6 seconds or less, such as about 5 seconds or less, such as about 4 seconds or less, such as about 3 seconds or less, such as about 2 seconds or less, such as about 1 second or less.

Generally, various different laminating processes may be used to laminate a film 118a to a substrate 100. For instance, a film 118a may be laminated to a substrate 100 via vacuum thermoforming, drape forming, high pressure forming, plug assist forming, hydroforming, or match die forming.

In one aspect, pressure may be applied to the film 118a to form a film layer 118b on a substrate 100. In this respect, in one aspect, a heated platen may be placed in communication with a pneumatic gas source, such as a pneumatic air source for then applying pressure to a heated film 118a. For example, pneumatic pressure can be applied from the heated platen to a film 118a in an amount greater than about 300 psi, such as greater than about 350 psi, such as greater than about 400 psi, such as greater than about 425 psi, such as greater than about 435 psi, such as greater than about 445 psi, and generally less than about 550 psi, such as less than about 500 psi. The pneumatic pressure forces the film 118a against the interior substrate surface of the substrate 100 and may cause the heated film to not only bond to the substrate 100 but also assume the shape of the substrate 100.

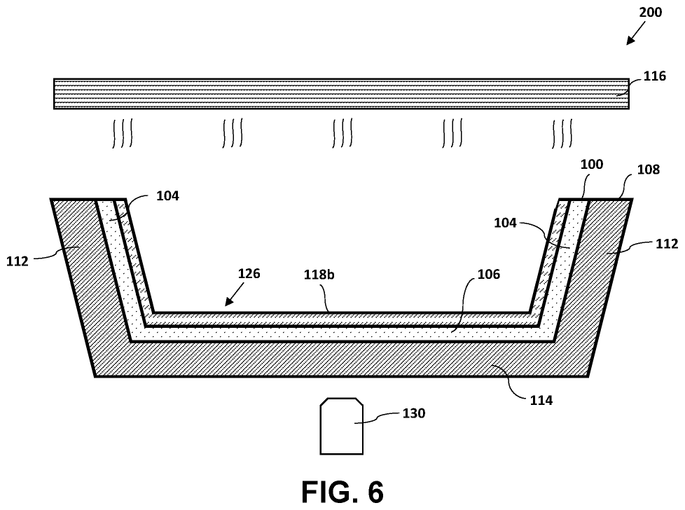

As illustrated in FIG. 6, a film layer 118b may be laminated to a substrate 100. For illustrative purposes, a series of three-line groupings were utilized in FIG. 6 to represent heat emanating from the one or more heating elements 116. In one aspect, the film layer 118b may form and/or define an interior article surface 126. As previously disclosed, the film layer 118b can be formed with excellent optical properties. For instance, the film layer 118b can be highly transparent or translucent and can have very low haze properties. Thus, in one embodiment, printed matter including various designs may be applied to the substrate 100 and can be visible through the film layer 118b after the film 118a is laminated to the substrate 100. The printed matter can include instructions such as how to store and/or heat a food product contained within an article. Alternatively, the printed matter may include decorative designs and images, patterns, trademarks, logos, and the like.

In general, printed matter may be applied to the substrate 100, the film 118a, or the film layer 118b using any suitable method. For instance, the substrate 100, the film 118a, or the film layer 118b may be subjected to screen printing, laser marking, pad printing, digital printing, dye sublimation, transfer printing, offset printing, digital offset printing, or gravure printing. In one aspect, laser marking is used instead of printing.

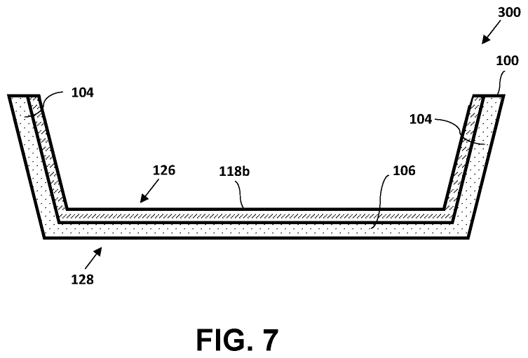

As illustrated in FIG. 7, an article 300 formed in accordance with the present disclosure may comprise a film layer 118b and a substrate 100. It should be understood that FIG. 7 is a cross-sectional view in which a side wall of a trapezoidal substrate 100 and the corresponding film layer 118b are not illustrated. In general, at least a portion of a film 118a may bond to at least a portion of a substrate 100 and form a film layer 118b. In this aspect, at least a portion of a film surface may bond to at least a portion of an interior substrate surface. Notably, in one aspect, a film layer 118b may be formed from the heating of a film 118a with one or more heating elements 116 such that the film 118a conforms to the substrate 100 to form a film layer 118b. As previously disclosed herein, in one aspect, the film layer 118b may form and/or define an interior article surface 126. Further, in one aspect, the substrate 100 may form an exterior article surface 128. In another aspect, the film layer 118b may form at least a portion of the exterior article surface. In one aspect, the film layer 118b may form at least a portion of the interior article surface and the exterior article surface.

Through the process of the present disclosure, a very durable and strong bond may be formed between the film layer 118b and a surface of the substrate 100. For example, when tested according to a peel test, such as ASTM Test D6862-11 (2021), the film layer 118b can have an average bond strength of greater than about 0.75 N, such as greater than about 1.15 N, such as greater than about 1.5 N, such as greater than about 1.75 N, and generally less than about 4 N when tested at a speed of 12 inches per minute. The bond can be formed using an adhesive as a tie layer. Alternatively, the cellulose ester film can bond directly to the fibrous substrate.

In addition to having a significant bond strength, the bond that forms between the film layer 118b and a surface of the substrate 100 may also very durable. For instance, the film layer 118b may not delaminate from the substrate 100 even when subjected to freeze and rapid thaw/cook cycles. For example, an article 300 formed in accordance with the present disclosure may withstand a test in which the article is filled 85% full of water that is frozen in the article for a minimum of four hours. Next, the water is then thawed in a microwave oven on high and brought to a boil for two minutes. Notably, even in this test, no delamination of a film layer 118b may occur.

### Examples

A system and method as disclosed herein were utilized to produce articles in accordance with the present disclosure. For each sample, a 3-dimensional trapezoidal substrate was positioned in a substrate holder. The draw ratio for each sample was 1.9. For each sample, a film was positioned above the 3-dimensional trapezoidal substrate and the substrate holder. Next, radiant heat was generated by a heating element to increase the temperature of the film to an initial forming temperature of a forming temperature range. The initial forming temperature of each sample was 180° C. Then, a suction force was applied to the film by a vacuum while the film was maintained at a forming temperature of a forming temperature range. The suction force manipulated the film such that the film conformed and bonded to the corners and edges of the substrate. As used herein, film type “FT1” refers to a film comprising 80 wt. % cellulose acetate with 20 wt. % triacetin. As used herein, film type “FT2” refers to a film comprising 85 wt. % cellulose acetate with 15 wt. % triacetin. As used herein, film type “FT3” refers to a film comprising 85 wt. % cellulose acetate with 15 wt. % triacetin and an adhesive layer comprising a biopolymer, such as a soy protein based adhesive. As used herein, film type “FT4” refers to a film comprising 85 wt. % cellulose acetate with 15 wt. % triacetin and an adhesive layer comprising polybutylene succinate. As used herein, film type “FT5” refers to a film comprising 85 wt. % cellulose acetate with 15 wt. % triacetin and an adhesive layer comprising polyvinyl alcohol.

TABLE 1

| | | | Heating | Heating | | |
|---|---|---|---|---|---|---|
| | | Film | Element | Cycle | Vacuum | Cycle |
| | Film | Thickness | Temperature | Time | Duration | Time |
| Sample | Type | [μm] | [° C.] | [s] | [s] | [s] |
| 1 | FT1 | 115 | 240 | 15 | 5 | 20 |
| 2 | FT1 | 115 | 240 | 13 | 5 | 18 |
| 3 | FT2 | 95 | 240 | 10 | 5 | 15 |
| 4 | FT2 | 95 | 240 | 15 | 5 | 20 |
| 5 | FT2 | 95 | 240 | 13 | 5 | 18 |
| 6 | FT2 | 75 | 240 | 10 | 5 | 15 |
| 7 | FT2 | 75 | 240 | 15 | 5 | 20 |
| 8 | FT2 | 75 | 240 | 13 | 5 | 18 |
| 9 | FT2 | 50 | 240 | 10 | 5 | 15 |
| 10 | FT2 | 50 | 240 | 15 | 5 | 20 |
| 11 | FT2 | 50 | 240 | 13 | 5 | 18 |
| 12 | FT1 | 115 | 290 | 5 | 5 | 10 |
| 13 | FT2 | 95 | 290 | 5 | 5 | 10 |
| 14 | FT2 | 95 | 290 | 3 | 5 | 8 |
| 15 | FT2 | 75 | 290 | 5 | 5 | 10 |
| 16 | FT2 | 75 | 290 | 3 | 5 | 8 |
| 17 | FT2 | 50 | 290 | 5 | 5 | 10 |
| 18 | FT2 | 50 | 290 | 3 | 5 | 8 |
| 19 | FT2 | 44 | 240 | 5 | 5 | 10 |
| 20 | FT2 | 44 | 240 | 3 | 5 | 8 |
| 21 | FT2 | 44 | 240 | 5 | 5 | 10 |
| 22 | FT2 | 30 | 240 | 3 | 5 | 8 |
| 23 | FT2 | 30 | 240 | 5 | 5 | 10 |
| 24 | FT2 | 30 | 240 | 3 | 5 | 8 |
| 25 | FT2 | 44 | 290 | 5 | 5 | 10 |
| 26 | FT2 | 44 | 290 | 3 | 5 | 8 |
| 27 | FT2 | 30 | 290 | 5 | 5 | 10 |
| 28 | FT2 | 30 | 290 | 3 | 5 | 8 |
| 29 | FT2 | 24 | 290 | 5 | 5 | 10 |
| 30 | FT2 | 24 | 290 | 3 | 5 | 8 |
| 31 | FT2 | 24 | 240 | 10 | 5 | 15 |
| 32 | FT2 | 24 | 240 | 15 | 5 | 20 |
| 33 | FT2 | 24 | 240 | 13 | 5 | 18 |
| 34 | FT2 | 24 | 240 | 18 | 5 | 23 |
| 35 | FT2 | 24 | 240 | 20 | 5 | 25 |
| 36 | FT2 | 20 | 240 | 10 | 5 | 15 |
| 37 | FT2 | 20 | 240 | 20 | 5 | 25 |
| 38 | FT2 | 14 | 240 | 10 | 5 | 15 |
| 39 | FT2 | 14 | 240 | 20 | 5 | 25 |
| 40 | FT2 | 20 | 290 | 5 | 5 | 10 |
| 41 | FT2 | 20 | 290 | 3 | 5 | 8 |
| 42 | FT2 | 14 | 290 | 5 | 5 | 10 |
| 43 | FT2 | 14 | 290 | 3 | 5 | 8 |
| 44 | FT3 | 70 | 290 | 5 | 5 | 10 |
| 45 | FT3 | 50 | 290 | 5 | 5 | 10 |
| 46 | FT5 | 45 | 290 | 5 | 5 | 10 |
| 47 | FT4 | 67 | 290 | 5 | 5 | 10 |
| 48 | FT4 | 40 | 290 | 5 | 5 | 10 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A method of thermoforming a film to a substrate comprising:
positioning a substrate within a substrate holder, the substrate defining a substrate surface;
positioning a film relative to the substrate, the film also being positioned relative to a heating element, the film and the substrate forming a film-substrate cavity between the film and the substrate, the film defining a film surface, the film comprising a biodegradable and/or paper recyclable polymer;
generating heat with the heating element such that the heat from the heating element increases the temperature of the film, wherein the heat from the heating element increases the temperature of the film to a forming temperature range; and
applying a suction force to the film, the suction force being applied through the substrate and the substrate holder, the suction force manipulating the film such that the film contacts at least a portion of the substrate surface while the film remains within the forming temperature range, the suction force manipulating the film such that the portion of the film conforms to at least a portion of the substrate surface.

2. The method of claim 1, wherein the substrate and/or substrate holder is permeable to air.

3. The method of claim 1, wherein the heat from the heating element is radiant heat, wherein the step of applying a suction force to the film further comprises maintaining the generation of radiant heat.

4. The method of claim 1, wherein the substrate is perforated, wherein a bottom wall and one or more side walls of the substrate are perforated.

5. The method of claim 1, wherein the film-substrate cavity comprises air, wherein the step of applying a suction force to the film further comprises a withdrawal of air from the film-substrate cavity, the withdrawal of air from the film-substrate cavity resulting in the portion of the film surface moving closer to the portion of the substrate surface until the portion of the film surface contacts the portion of the substrate surface.

6. The method of claim 1, wherein the step of applying a suction force to the film further comprises bonding of the portion of the film surface to the portion of the substrate surface, an interior surface of the substrate comprising the portion of the substrate surface, the interior surface of the substrate defining a substrate cavity.

7. The method of claim 1, wherein the step of applying a suction force to the film further comprises maintaining the film at the forming temperature range.

8. The method of claim 1, wherein the heating element is spaced from the film at a distance of about 10 mm to about 200 mm.

9. The method of claim 1, wherein the forming temperature range of the film is from about 150° C. to about 220° C.

10. The method of claim 1, wherein the forming temperature range of the film is from about 160° C. to about 200° C.

11. The method of claim 1, wherein the suction force applied to the film is from about −0.1 bar to about −2 bar.

12. The method of claim 1, wherein the suction force is applied to the film for a period of from about 1 second to about 20 seconds.

13. The method of claim 1, wherein the film has a thickness of from about 5 microns to about 100 microns.

14. The method of claim 1, wherein the substrate has a three-dimensional shape.

15. The method of claim 1, wherein the biodegradable and/or paper recyclable polymer comprises a cellulose ester polymer, wherein the cellulose ester polymer comprises a cellulose acetate, the cellulose acetate comprising primarily cellulose diacetate.

16. The method of claim 1, wherein the film contains the cellulose ester polymer in an amount from about 55% to about 95% by weight and contains a plasticizer in an amount from about 5% by weight to about 45% by weight.

17. The method of claim 1, wherein an adhesive composition is applied to the film surface before the step of generating heat with the heating element.

18. The method of claim 17, wherein the adhesive composition comprises an acrylic-based polymer.

19. The method of claim 1, wherein the film is water resistant.

20. The method of claim 1, wherein the substrate comprises a biodegradable and/or paper recyclable fibrous material.
